(19) United States
(12) Patent Application Publication
(10) Pub. No.: US 2010/0242988 A1
(43) Pub. Date: Sep. 30, 2010

(54) METHOD AND APPARATUS FOR CLEANING A COMPONENT USING MICROWAVE RADIATION

(76) Inventors: Chee Kin Woo, Singapore (SG); Balaji Rao Garimella, Singapore (SG); Kok Hai Luah, Singapore (SG); Jun Hao Foo, Singapore (SG)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 12/474,713

(22) Filed: May 29, 2009

(30) Foreign Application Priority Data
Mar. 25, 2009 (SG) 200902056.1

(51) Int. Cl. B08B 3/10

(52) U.S. Cl. 134/1; 134/57 R; 134/105

(57) ABSTRACT

A method for cleaning a component having an undesired substance thereon includes exposing the component to a cleaning solution and irradiating the component with microwave radiation to assist in removing the undesired substance.

### RELATED APPLICATION

This application claims priority to Singapore Patent Application No. 200902056.1, which was filed Mar. 25, 2009.

### BACKGROUND OF THE INVENTION

This disclosure relates to a method and equipment for assisting in removal of undesired substances from components, such as gas turbine engine components.

There are a variety of generally known methods for removal of undesired substances from surfaces of a component. For instance, gas turbine engine blades and vanes may corrode from exposure to elevated temperatures and exposure to the exhaust stream of the engine. Type I sulphidation corrosion occurs at about 815-954° C. (1499-1749° F.) and Type II sulphidation corrosion occurs at about 704-954° C. (1299-1749° F.). Gas turbine engine vanes and blades may be refurbished after a period of use in the engine using a refurbishment process that may include stripping any coatings off of the component, removing corroded portions of the component, rebuilding portions of the component, and depositing a coating onto the repaired component before reinstallation into the engine.

To remove substances on the component, such as prior coatings, corrosion products, or the like, refurbishers may employ chemical methods, mechanical methods, or both. At least some known conventional chemical methods may include immersion of the component in one or more solutions for hours or even days to fully remove the substance. However, these known conventional chemical methods are often very slow in order to prevent chemically attacking the base substrate material of the component.

At least some known mechanical methods may include grit blasting or other abrasive techniques. Although the rate of removal for mechanical methods is much greater than chemical methods, mechanical methods often undesirably remove a portion of the base substrate of the component.

### SUMMARY OF THE INVENTION

An exemplary method for cleaning a component having an undesired substance thereon includes exposing the component to a cleaning solution and irradiating the component with microwave radiation to assist in removing the undesired substance from the component.

An exemplary cleaning apparatus includes a chamber configured to expose a component to a cleaning solution and a microwave source for irradiating the chamber with microwave radiation to assist in removing an undesired substance from the component.

These and other features of the present invention can be best understood from the following specification and drawings, the following of which is a brief description.

### BRIEF DESCRIPTION OF THE DRAWINGS

The various features and advantages of the disclosed examples will become apparent to those skilled in the art from the following detailed description. The drawings that accompany the detailed description can be briefly described as follows.

FIG. 1 illustrates an example method for cleaning a component having an undesired substance.

FIG. 2 illustrates an example cleaning apparatus for cleaning the component having the undesired substance.

FIG. 3 illustrates a portion of the component being cleaned using the example cleaning method and apparatus illustrated in FIGS. 1 and 2.

### DETAILED DESCRIPTION OF THE PREFERRED EMBODIMENT

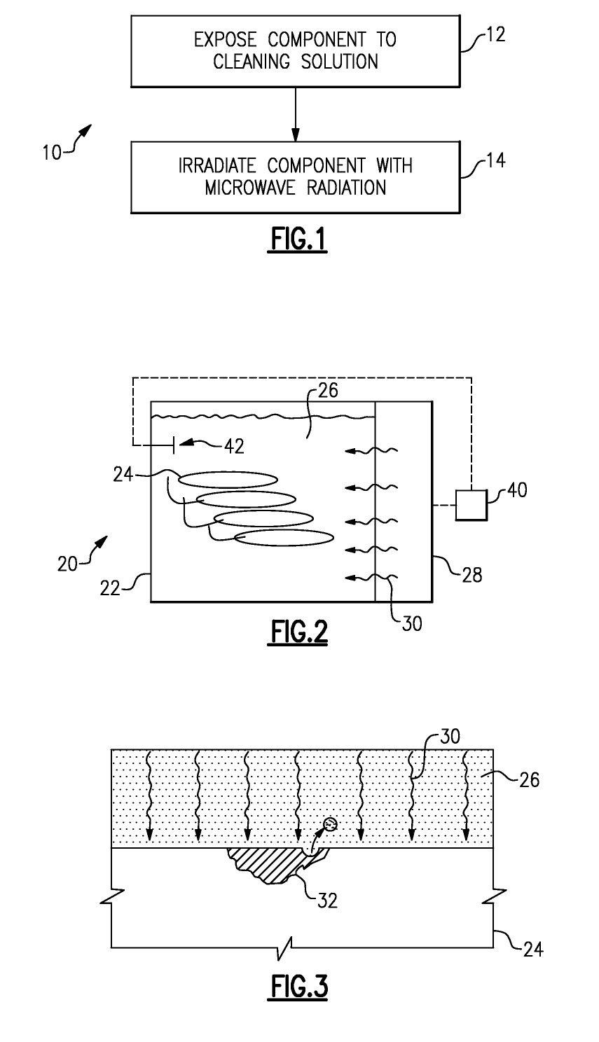

FIG. 1 illustrates an example method 10 for cleaning a component having an undesired substance on a substrate surface of the component. The type of component is not limited to any particular type and may be, for example, a gas turbine engine blade or vane. Likewise, the undesired substance that is to be removed from the component is not limited to any particular type and may be, for example, a corrosion product or prior coating on the component. For instance, the undesired substance may be bonded (e.g., chemically and/or mechanically) to the surface of the component. The corrosion product may be sulphidation that results from exposure of the turbine blade or vane component to elevated temperatures in the presence of sulfides in the exhaust stream of a gas turbine engine. In this regard, the method 10 may be employed as part of a refurbishment process for repairing a gas turbine engine component such as a turbine blade or vane.

The method 10 includes a step 12 of exposing the component to a cleaning solution, and a step 14 of irradiating the component with microwave radiation. For instance, the cleaning solution and the microwave radiation may assist in removing the substance. The cleaning solution and microwave radiation may separate the substance from a substrate surface of the component or, alternatively, loosen the substance such that a subsequent removal action can more easily remove the substance from a substrate surface of the component. As may be appreciated, the method 10 may be part of a refurbishment or repair process having additional processing steps, such as rebuilding portions of the component or depositing a coating onto the repaired component.

The type of cleaning solution selected in the example method 10 is not limited to any particular type and may depend, for example, on the base materials of the component. For instance, if the component is a gas turbine engine blade or vane, the component may be fabricated from a metallic alloy, such as a nickel-based alloy. In this example, the cleaning solution may be an acidic cleaning solution to assist in removing undesired corrosion substances from the surfaces of the metallic alloy component.

As an example, the acidic cleaning solution may include hydrochloric acid, nitric acid, or both, to loosen and/or remove the substance. The acidic cleaning solution may include a ratio of 2-5 parts of hydrochloric acid to 1 part of nitric acid in an aqueous solution. In a further example, the acidic cleaning solution may have a relatively aggressive composition that includes about 39 vol % hydrochloric acid, about 13 vol % nitric acid, and about 48 vol % of water. Alternatively, the acidic cleaning solution may have a less aggressive composition that includes about 3.9 vol % hydrochloric acid, about 1.3 vol % nitric acid, and about 94.8 vol % of water. The aggressiveness (i.e., pH) of the acidic cleaning solution may be selected based on the base material type of the component, substance that is intended to be removed, or cleaning process parameters, for example. It is to be understood that the given example acidic cleaning solutions may additionally include other constituents in the composition or, alternatively, may include only the given constituents in the composition or other constituents that do not materially affect the cleaning.

The given example cleaning solutions have weaker acidity or fewer acidic constituents than conventional cleaning solutions, yet reduce the cleaning processing time when used in the method 10 as compared to some known conventional cleaning methods. That is, using the microwave radiation accelerates the reaction kinetics between the cleaning solution and the substance such that less aggressive cleaning solutions become effective and time efficient. Using a less aggressive cleaning solution in combination with the microwave radiation also facilitates reducing risk of chemically attacking the base material of the component.

Exposing the component to the cleaning solution may include immersing the component in a bath of the cleaning solution. The temperature of the cleaning solution may be about 28-80° C. (82.4-176° F.) and the time of irradiating the component may be about 1-15 minutes. Given this description, one of ordinary skill in the art will recognize other temperatures and processing times to suit their particular application. Longer or shorter times may be used, respectively, for a faster or slower rate of reaction. Likewise, warmer or cooler temperatures may be used, respectively, for a greater or lesser degree of removal. A warmer temperature however, may result in a greater rate of evaporation of the cleaning solution.

The power of the microwave radiation may also be adjusted in response to a detected temperature of the cleaning solution in order to maintain the temperature within the given range. The temperature of about 28-80° C. (82.4-176° F.) facilitates providing favorable reaction kinetics but is not so high as to rapidly evaporate the cleaning solution, which could otherwise change the composition of the cleaning solution over time.

The premise of the example embodiments is that the inventors discovered that microwave radiation may facilitate heating the local area of the undesired substance by preferentially heating the undesired substance more than the clean portions of the component. The local temperature increase of the cleaning solution increases the reaction kinetics at the liquid-solid interface of the solution and the undesired substance. The removal process thereby proceeds at an increased rate compared to cleaning processes that do not use microwave radiation.

FIG. 2 illustrates an example cleaning apparatus 20 for employing the method 10. In this example, the cleaning apparatus 20 includes a chamber 22 for exposing one or more components 24 to a cleaning solution 26. A microwave source 28 may be located near the chamber 22 to irradiate the chamber 22 with microwave radiation 30 to assist in removing an undesired substance 32 (see FIG. 3) from the component 24. For instance, the microwave source 28 may be built-in to a wall of the chamber 22, such as a side wall or bottom wall. The chamber 22 may additionally include shielding (not shown) for containing the microwave radiation 30 within the chamber 22.

As illustrated, the chamber 22 is a tank for holding the cleaning solution 26 to immerse the components 24. However, the chamber 22 may alternatively be another type of container for exposing the component 24 to the cleaning solution 26. In this regard, the cleaning solution 26 need not be an immersion bath and may alternatively be sprayed or otherwise applied to the component in the chamber 22.

Referring also to FIG. 3, the undesired substance 32 is located near the surface of the component 24. The undesired substance 32 may be a corrosion product, such as sulphidation, from use under elevated temperature conditions in the presence of sulphides. The microwave source 28 emits the microwave radiation 30, which travels through the cleaning solution 26 toward the component 24. At least a portion of the microwave radiation 30 impinges upon the undesired substance 32 and thereby assists in removal of the substance 32 from the component 24 as described above.

The cleaning apparatus 20 may also include a controller 40. In this case, the controller 40 is in communication with the microwave source 28 and a thermocouple 42 at least partially within the chamber 22. The thermocouple 42 detects the temperature of the cleaning solution 26 and transmits a representative signal to the controller 40. The controller 40 is programmed to control the microwave source 28 in response to the temperature.

As an example, the controller 40 may adjust the power of the microwave radiation 30 in response to the temperature. Alternatively, the controller 40 may turn the microwave source 28 off or on in response to the temperature. The “power” of the microwave radiation may refer to the frequency of the microwave radiation 30 or, alternatively, to the wavelength of the microwave radiation 30 and/or the time duration where the microwave source is turned on. Microwave radiation 30 has a wavelength ranging from one millimeter to one meter, or a frequency of 0.3-300 gigahertz. Thus, the controller 40 may command the microwave source 28 to adjust the power of the microwave radiation 30 within the given ranges or command the microwave source to irradiate, for example, 50% of the time if it is set to half-power.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A method for cleaning a component having an undesired substance thereon, comprising:
exposing the component to a cleaning solution; and
irradiating the component with microwave radiation to assist in removing the undesired substance from the component.

2. The method as recited in claim 1, wherein the cleaning solution is acidic.

3. The method as recited in claim 1, wherein the cleaning solution includes hydrochloric acid.

4. The method as recited in claim 1, wherein the cleaning solution includes nitric acid.

5. The method as recited in claim 1, wherein the cleaning solution includes a ratio of 2-5 parts hydrochloric acid to 1 part nitric acid.

6. The method as recited in claim 1, wherein the cleaning solution includes about 39 vol % hydrochloric acid, about 13 vol % nitric acid, and about 48 vol % water.

7. The method as recited in claim 1, wherein the cleaning solution includes about 3.9 vol % hydrochloric acid, about 1.3 vol % nitric acid, and about 94.8 vol % of water.

8. The method as recited in claim 1, including irradiating the component for about 1-15 minutes.

9. The method as recited in claim 1, further comprising controlling the irradiating of the component in response to a temperature of the cleaning solution.

10. The method as recited in claim 1, further comprising establishing a temperature of the cleaning solution that is about 28-80° C. (82.4-176° F.).

11. The method as recited in claim 1, wherein the cleaning solution consists essentially of hydrochloric acid, nitric acid, and water.

12. The method as recited in claim 1, wherein the exposing of the component to the cleaning solution includes immersing the component in a bath of the cleaning solution.

13. The method as recited in claim 1, wherein the undesired substance on the component is a sulphidation corrosion product of a substrate of the component.

14. A cleaning apparatus for cleaning a component having an undesired substance thereon, comprising:
a chamber configured to expose a component to a cleaning solution; and
a microwave source for irradiating the chamber with microwave radiation to assist in removing an undesired substance from the component.

15. The cleaning apparatus as recited in claim 14, wherein the chamber is a tank for holding the cleaning solution.

16. The cleaning apparatus as recited in claim 14, further comprising a thermocouple at least partially within the chamber.

17. The cleaning apparatus as recited in claim 16, further comprising a controller in communication with the thermocouple and the microwave source, and the controller is configured to control the microwave source in response to a signal from the thermocouple that represents a temperature of the cleaning solution.
